(19) United States
(12) Patent Application Publication
(10) Pub. No.: US 2026/0192430 A1
(43) Pub. Date: Jul. 9, 2026

(54) INDICATOR SYSTEMS AND METHODS FOR A HYDRAULIC TOOL

(71) Applicant: Milwaukee Electric Tool Corporation, Brookfield, WI (US)

(72) Inventors: Samir Kumar; Brandon D. Meister, Brookfield, WI (US); Andrew Norton, Brookfield, WI (US)

(21) Appl. No.: 19/441,243

(22) Filed: Jan. 6, 2026

Related U.S. Application Data
(60) Provisional application No. 63/742,252, filed on Jan. 6, 2025.

(51) Int. Cl. B25F 5/00; B25F 5/02; F21V 33/00; F21Y 115/10

(52) U.S. Cl. CPC B25F 5/005; B25F 5/02; F21V 33/0084; F21Y 2115/10

(57) ABSTRACT

A hydraulic tool includes a tool housing, the tool housing including a pedestal extending from the tool housing and defined by a first bezel and a second bezel on opposing sides of the pedestal, a head at a first end of the tool housing, the head to apply a mechanical force to a work piece, and an indicator system. The indicator system includes a first portion, the first portion including a lens extending through the first bezel of the pedestal, and a printed circuit board having a non-RGB LED and an RGB LED arranged underneath the same lens, the non-RGB LED and the RGB LED arranged to emit light through the same lens.

### CROSS-REFERENCE TO RELATED APPLICATIONS

This application claims priority to U.S. Provisional Application No. 63/742,252, filed January 6, 2025, which is hereby incorporated by reference in its entirety.

### BACKGROUND

A hydraulic tool can be used to crimp, shear, or cut a work piece, among other examples. In such tools, a hydraulic pump is typically utilized for actuating the tool. For example, the force exerted by the pump can be used for closing jaws of the tool to perform a crimping, cutting, or shearing action on the work piece at a desired location. In some cases, it can be difficult for a user to determine whether the tool has performed a proper crimp, shear, or cut of the work piece. For example, deviations from acceptable tolerance ranges for some crimping, shearing, or cutting actions can be hard to detect by visual inspection.

### SUMMARY

According to one aspect of the present disclosure, a hydraulic tool can include a tool housing. The tool housing can include a pedestal extending from the tool housing and defined by a first bezel and a second bezel on opposing sides of the pedestal. A head can be positioned at a first end of the tool housing. The head can apply a mechanical force to a work piece. An indicator system can include a first portion. The first portion can include a lens extending through the first bezel of the pedestal. A printed circuit board can have a non-RGB LED and an RGB LED arranged underneath the same lens. The non-RGB LED and the RGB LED can be arranged to emit light through the same lens.

In some examples, the indicator system can further include a second portion. The second portion can include a lens extending through the second bezel of the pedestal. A printed circuit board can have an RGB LED arranged underneath the same lens. The RGB LED can be arranged to emit light through the same lens to indicate a status of the tool.

In some examples, the RGB LED of the first portion of the indicator system can emit light through the same lens to indicate a status of the tool. The non-RGB LED of the first portion of the indicator system can emit light through the same lens to illuminate a work piece during operation of the tool.

In some examples, the first portion of the indicator system can emit light in a first direction and the second portion of the indicator system can emit light in a second direction that is opposite the first direction.

In some examples, the hydraulic tool can be configured to make a first determination that a cutting, crimping, or shearing operation that satisfies a predetermined criterion has been performed on the work piece by the head. The hydraulic tool can cause the indicator system to emit a first light color that corresponds to the first determination.

In some examples, the hydraulic tool can be configured to make a second determination that a cutting, crimping, or shearing operation that satisfies a predetermined criterion has not been performed on the work piece by the head. The hydraulic tool can cause the indicator system to emit a second light color that corresponds to the second determination.

In some examples, the first portion of the indicator system can include a first lens and a second lens. The printed circuit board can have a non-RGB LED and an RGB LED arranged underneath both the first lens and the second lens.

In some examples, the printed circuit board can define a semi-circular shape.

According to another aspect of the present disclosure, a method of indicating a status of a hydraulic tool can include providing a hydraulic tool having a housing, a working head coupled to the housing, and an indicator system including a lens with a non-RGB LED and an RGB LED arranged underneath the lens. The method can include performing a work operation on a work piece using the working head. The method can include determining whether the work operation satisfies a predetermined criterion. The method can include causing the RGB LED to emit light through the lens in a first color when the work operation satisfies the predetermined criterion and in a second color, different from the first color, when the work operation does not satisfy the predetermined criterion.

In some examples, the method can further include emitting light from the non-RGB LED through the lens to illuminate the work piece during the work operation.

In some examples, the non-RGB LED and the RGB LED can emit light simultaneously through the lens during the work operation.

In some examples, the housing can include a pedestal extending from the housing. The pedestal can be defined by a first bezel and a second bezel on opposing sides of the pedestal. The lens can extend through the first bezel.

In some examples, the non-RGB LED and the RGB LED can be mounted on a printed circuit board having a semi-circular shape.

In some examples, the indicator system can further include a second lens positioned on an opposing side of the housing from the lens. The method can further include emitting light from a second RGB LED through the second lens simultaneously with the RGB LED emitting light through the lens.

In some examples, the method can further include causing the RGB LED to flash, pulse, or emit light in a predetermined pattern to indicate a status of the hydraulic tool to an operator.

According to yet another aspect of the present disclosure, an indicator system for a hydraulic tool can include a pedestal extending away from a housing of the hydraulic tool. The pedestal can be defined by a first bezel facing a working head of the hydraulic tool and a second bezel facing away from the working head. A first lens can extend through the first bezel. A second lens can extend through the second bezel. A first printed circuit board can be positioned beneath the first lens. The first printed circuit board can have a non-RGB LED emitting light through the first lens to illuminate a work piece and an RGB LED emitting light through the first lens to indicate a status of the hydraulic tool. A second printed circuit board can be positioned beneath the second lens. The second printed circuit board can have an RGB LED emitting light through the second lens to indicate the status of the hydraulic tool.

In some examples, the RGB LED of the first printed circuit board and the RGB LED of the second printed circuit board can emit light simultaneously to indicate the status of the hydraulic tool.

In some examples, the first printed circuit board can define a semi-circular shape.

In some examples, the first bezel can define a sloped surface. The first lens can extend through an opening in the sloped surface.

In some examples, the first lens and the second lens can emit light in opposite directions.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a diagrammatic view of an example hydraulic tool according to aspects of the present disclosure.

FIG. 2 is a side view of an example of the hydraulic tool of FIG. 1 including an indicator system.

FIG. 3 is a top view of the hydraulic tool of FIG. 2.

FIG. 4 is an axonometric partial view of the hydraulic tool of FIG. 2.

FIG. 5 is a front partial view of the hydraulic tool of FIG. 2.

FIG. 6 is a side view of a first printed circuit board (PCB) for use with the indicator system of the hydraulic tool of FIG. 2.

FIG. 7 is a side view of a second printed circuit board (PCB) for use with the indicator system of the hydraulic tool of FIG. 2

FIG. 8 is a front partial view of the hydraulic tool of FIG. 2 including another example of an indicator system.

FIG. 9 is a front partial view of the hydraulic tool of FIG. 2 including another example of an indicator system.

FIG. 10 is a front partial view of the hydraulic tool of FIG. 2 including another example of an indicator system.

FIG. 11 is a front partial view of the hydraulic tool of FIG. 2 including another example of an indicator system.

FIG. 12 is a side view of the hydraulic tool of FIG. 2 including another example of an indicator system.

FIG. 13 is a side view of the hydraulic tool of FIG. 2 including a live wire indication system.

FIG. 14 is a flow chart illustrating an example use of the live wire indication system of FIG. 13.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown, but are to be accorded the widest scope consistent with the principles and features disclosed herein.

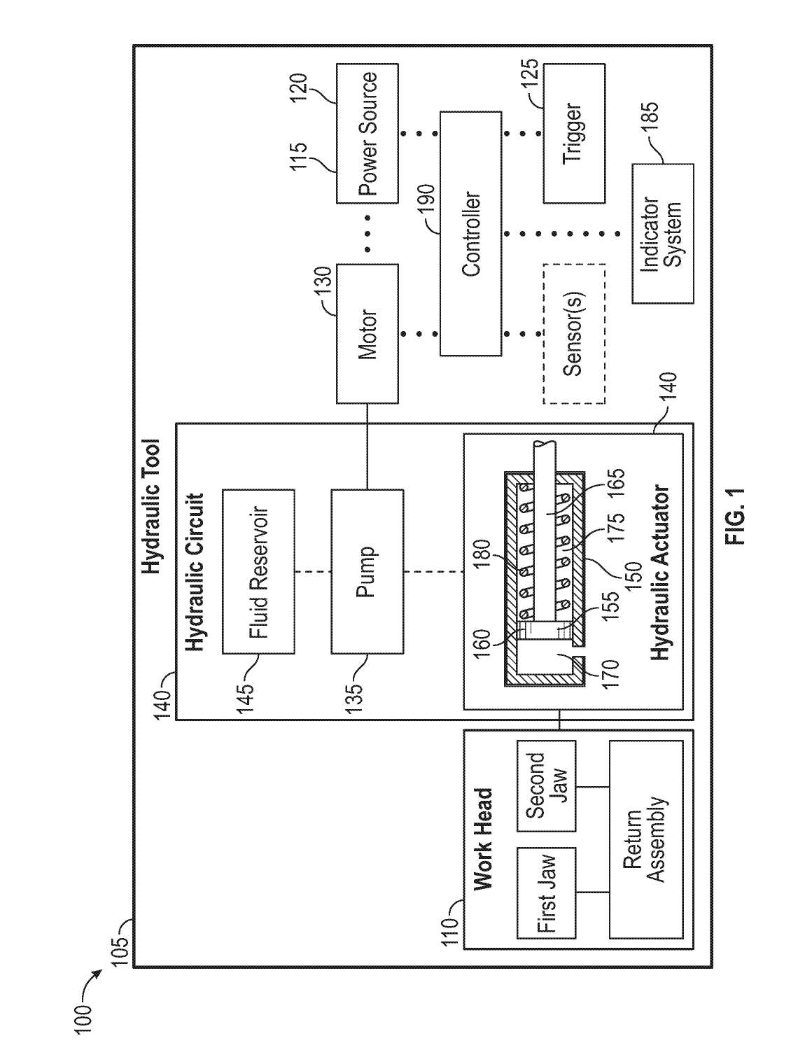

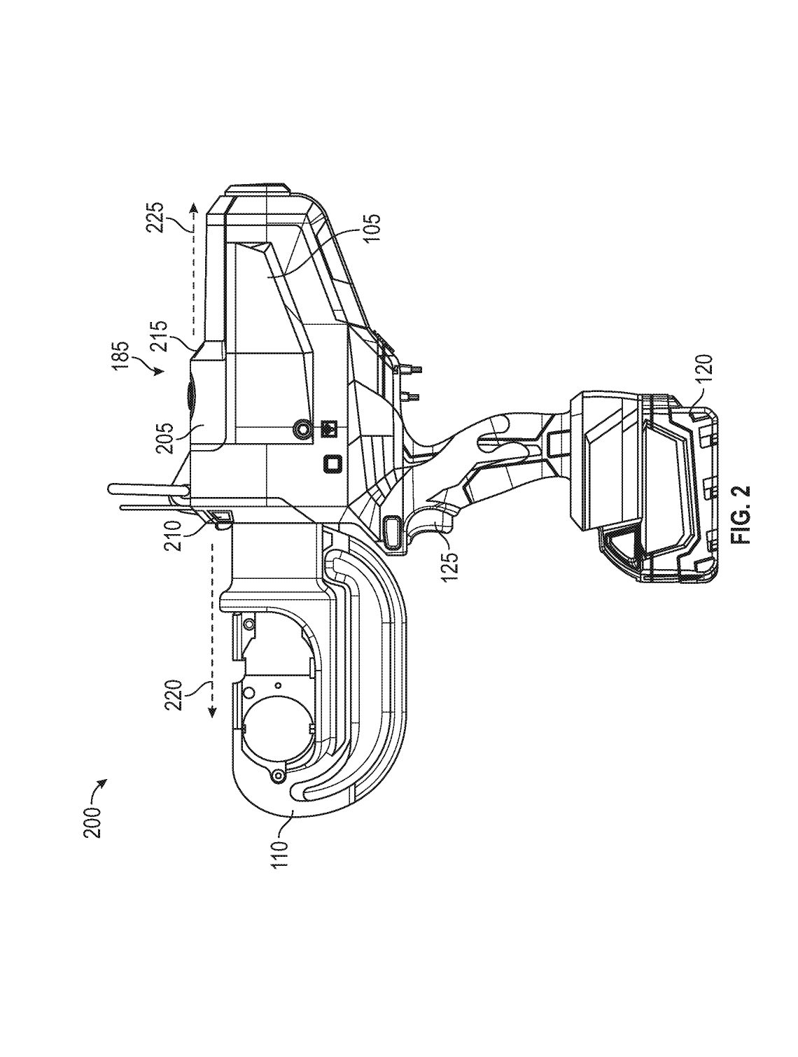

FIGS. 1 and 2 illustrate an example of a hydraulic tool 100, in accordance with the present disclosure. Although the example implementation described herein references a crimpling/cutting tool, the features of this disclosure can be implemented in other similar tools, such as shearing tools or punching tools. In addition, any suitable size, shape or type of elements or materials could be used. The illustrated hydraulic tool 100 includes a housing 105 and a working head 110 (e.g., including one or more jaws) that is coupled to the housing 105 to perform an operation (e.g., crimp, cut, etc.) on a work piece. In some examples, the hydraulic tool 100 may include a power source 115 in order to permit operation of the tool 100. In some examples, the tool 100 can be battery-operated and the power source 115 may be in the form of a battery 120 (e.g., a removable, rechargeable battery). In other examples the hydraulic tool 100 can be include a power cord (e.g., for alternating current (AC) power connections).

To operate the hydraulic tool 100, a trigger 125 may be coupled to the housing 105. The trigger 125 can be manipulated by a user to actuate the hydraulic tool 100 and perform the work operation. For example, actuating the trigger 125 can control operation of an output assembly that is disposed within the housing 105. The output assembly can include a motor 130, a pump 135, and a hydraulic actuator 140 that acts on the working head 110 to perform the work operation. When the trigger 125 is pressed, electrical current can flow from the battery 120 to output assembly, causing the output assembly to operate the working head 110 to perform the work operation.

In some cases, the trigger 125 can communicate with an electronic controller 190 (e.g., including a processor and a memory) that controls a flow of electrical current from the battery 120 or another power source. More specifically, the electrical current can be provided to the motor 130 of the output assembly. The motor 130 can be coupled to the pump 135 so that rotation of the motor 130 operates the pump 135 to supply pressurized hydraulic fluid to the hydraulic actuator 140. In some cases, the motor 130 can be coupled to the pump 135 via a transmission (e.g., a gear reducer).

Still referring to FIGS. 1-2, the pump 135 can supply hydraulic fluid from a reservoir 145 (e.g., a tank) to a hydraulic cylinder 150. In general, the hydraulic cylinder 150 includes a piston 155 having piston head 160 and a piston rod 165. The piston 155 is moveably received in the cylinder 150 to form a first chamber 170 and a second chamber 175 within an internal volume of the cylinder 150. In some cases, a piston seal is provided to seal between the piston head 160 and the cylinder 150 to prevent fluid from leaking between the first chamber 170 and the second chamber 175. Further, a rod seal is provided to seal between the cylinder 150 and the piston rod 165 to prevent hydraulic fluid from leaking out of the cylinder 150.

To operate the hydraulic actuator 140, the hydraulic cylinder 150 uses pressurized fluid to create mechanical motion. For example, hydraulic fluid is pumped into the first chamber 170. The pressure acting on the surface area of the piston 155 generates a force that causes the piston 155 to move within the cylinder 150 between a first position (e.g., a retracted position or an extended position) and a second position (e.g., the other of the retracted position and the extended position). In some cases, the hydraulic cylinder 150 is single acting. For example, hydraulic fluid is pumped to apply pressure to one side (e.g., first chamber 170) of the piston 155. Therefore, the piston 155 can only move in one direction by the generation of the force. A return mechanism 180 (e.g., spring or gravity) is used to return the piston 155 from the second position to the first position. In other cases, the hydraulic cylinder 150 is double-acting. For example, hydraulic fluid is pumped to apply pressure to both sides (e.g., the first chamber 170 and a second chamber 175) of the piston 155. Hydraulic fluid creates pressure along the surface in the first chamber 170, generating a force to move the piston 155 between the first position and the second position. To move the piston 155 between the second position and the first position, hydraulic fluid creates pressure along the surface in the second chamber 175 to generate a force.

In some examples, as mentioned previously, it can be difficult for an operator to determine whether the tool has performed a proper crimp, shear, or cut of the work piece. Thus, the tool 100 may include an indicator system 185. The indicator system 185 may be configured to provide a visual, audible, tactile, or other indication to an operator of whether or not a successful crimp, shear, cut, etc. has been completed. Further, in some examples, the indicator system 185 may further indicate to an operator that the tool 100 has a low battery, mechanical error has occurred, or other indicators that may be useful to an operator.

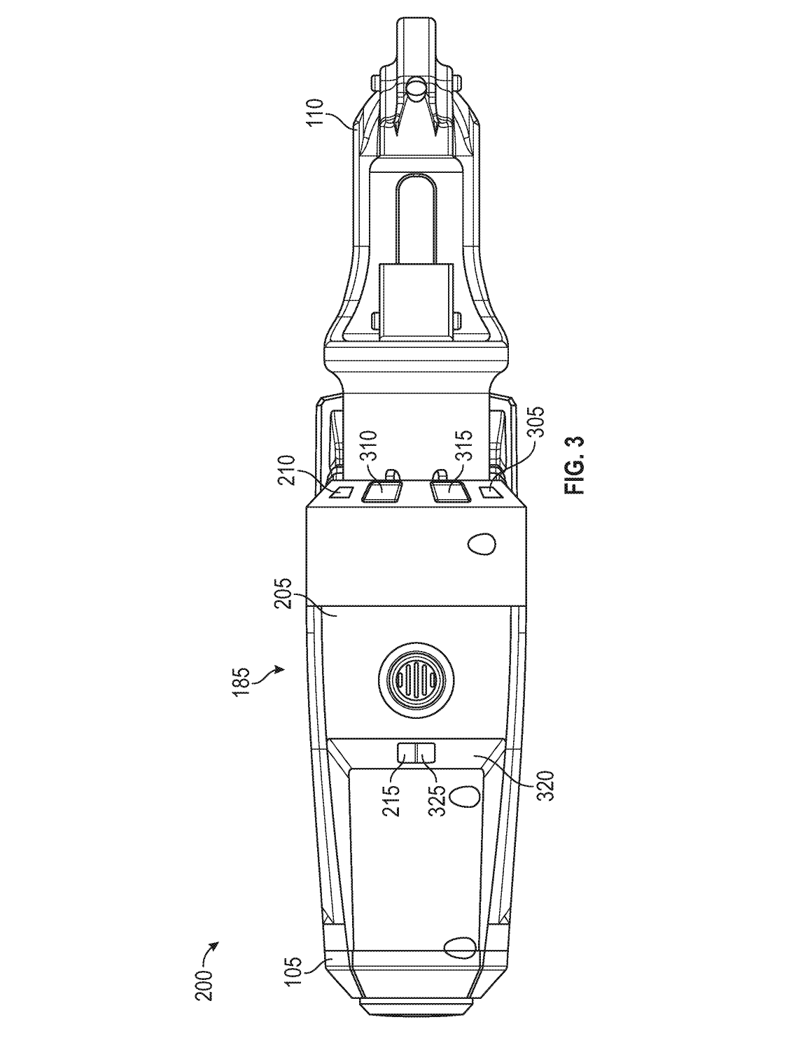

FIGS. 2 and 3 illustrate an example of a hydraulic tool 200 including the indicator system 185. In some examples, the indicator system 185 may be at least partially housed within the housing 105. For example, the housing 105 may include a raised portion (e.g., a pedestal) 205 that houses the indicator system 185. However, in other examples, the indicator system 185 may be positioned differently. For example, the indicator system 185 may be positioned within a grip (e.g., handle) of the tool 100, adjacent to the battery 120. In other examples, the indicator system 185 may be positioned in any other position on the housing 105 or the grip that may provide a view of the indicator system 185 to an operator. In some examples, in order to provide maximal visualization of the indicator system 185, the pedestal 205 may extend above the housing 105, so that a first portion 210 of the indicator system 185 provides a visualization path in the direction shown by arrow 220. Correspondingly, a second portion 215 of the indicator system 185 may provide a visualization path in the direction shown by arrow 225.

In some examples, the visualization paths defined by arrows 220, 225 may extend in opposite directions. For example, the first portion 210 of the indicator system 185 may provide an indication to an operator looking from the working head 110 towards the housing 105. Correspondingly, the second portion 215 of the indicator system 185 may provide an indication to an operator looking from an end of the tool 100 opposite the working head 110 (e.g., a rear of the tool 100). Thus, regardless of from which direction an operator is looking, the indicator system 185 may be viewable by the operator.

Further, in some examples, the pedestal 205 may include a first bezel 305, which may be adjacent to a connection point between the working head 110 and the housing 105. Further, the first bezel 305 may provide a sloped surface, which may include a first lens 310 and a second lens 315 of the first portion 210 of the indicator system 185. For example, the first and second lenses 310, 315 may extend through openings in the first bezel 305 in order to secure the first portion 210 of the indicator system 185 in position. In other examples, rather than including a pair of lenses (e.g., lenses 310, 315), the first portion 210 of the indicator system 185 may include only a single lens. In yet other examples, the first portion 210 of the indicator system 185 may include more then two lenses (e.g., three, four, etc.).

In some examples, opposite the first bezel 305, the pedestal 205 may include a second bezel 320, which may form a sloped surface including a first lens 325 of the second portion 215 of the indicator system 185. For example, the first lens 325 may extend through an opening in the second bezel 320 in order to secure the second portion 215 of the indicator system 185 in position. However, in other examples, the second portion 215 of the indicator system 185 may include more than a single lens (e.g., two, three, four, or more lenses). Further, as mentioned previously, light emitted from the second portion 215 of the indicator system 185 may be emitted in a direction about 180 degrees offset from the direction of light emitted from the first portion 210 of the indicator system 185.

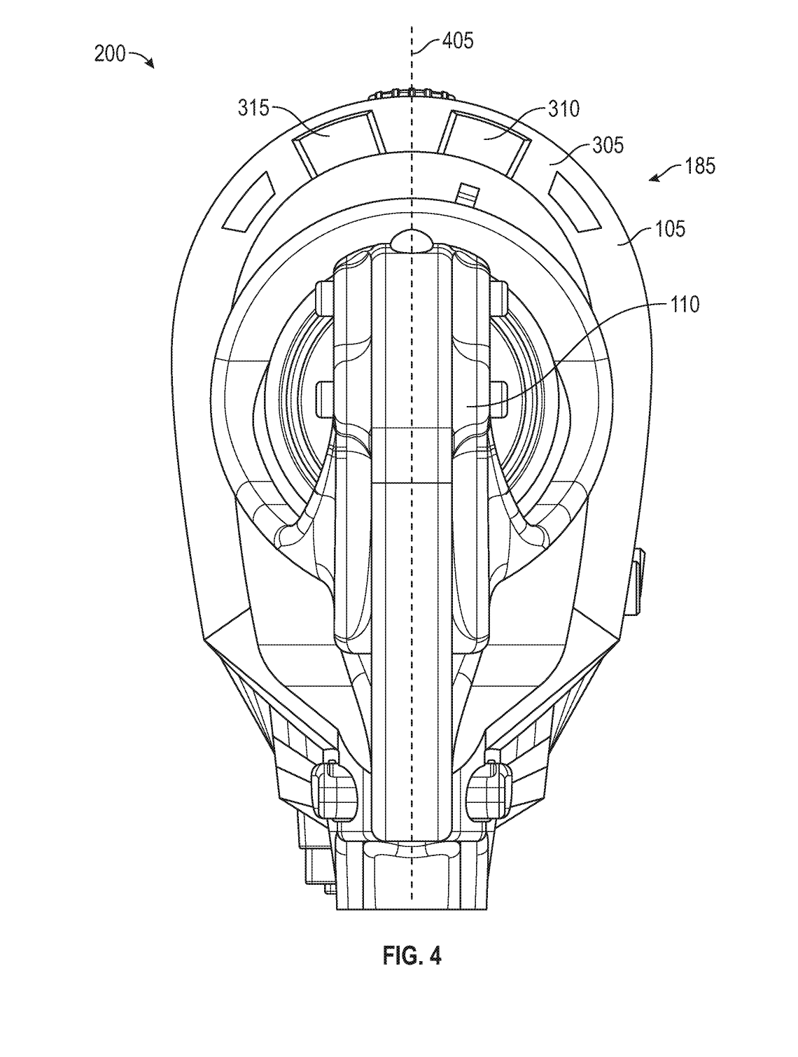

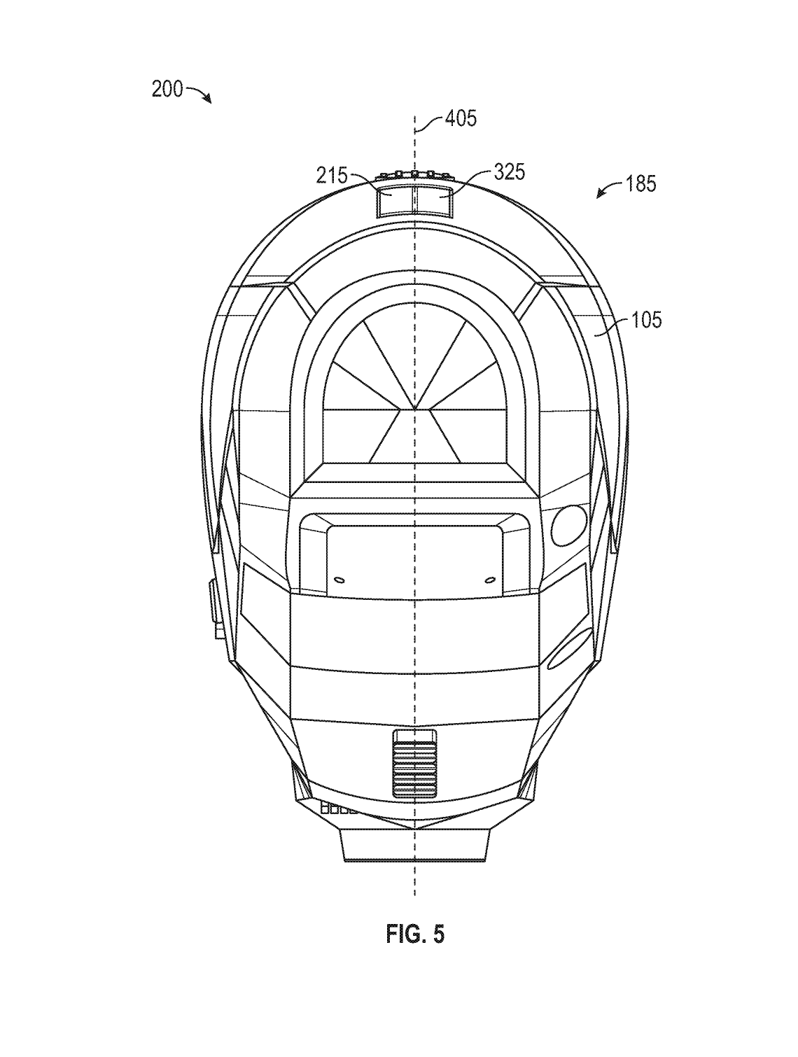

With reference to FIGS. 4 and 5, the first and second portions 210, 215 of the indicator system 185 may be said to align with respect to a central axis 405, which may correspond with a position of the working head 110. For example, as shown in FIG. 4, the first portion 210 of the indicator system 185 may be bisected by the central axis 405, with the first and second lenses 310, 315 about 10-30 degrees offset from the central axis 405. However, in other examples, the lenses may be offset from the central axis 405 by other angular offsets (e.g., 0-180 degrees offset). As shown in FIG. 5, the second portion 215 of the indicator system 185 may be bisected by the central axis 405, with the first lens 325 of the second portion 215 arranged on the central axis 405 (e.g., bisected by the central axis 405).

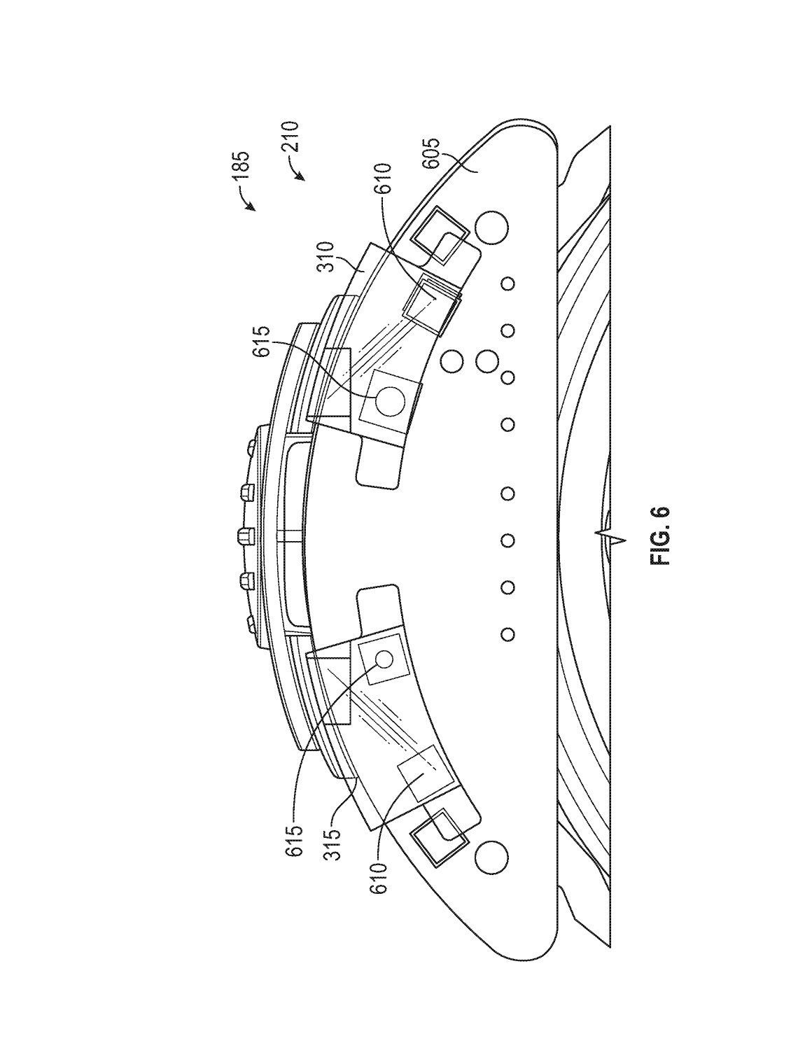

FIG. 6 shows an example of a printed circuit board (PCB) 605 for the first portion 210 of the indicator system 185. In some examples, the PCB may define a substantially semi-circular shape. However, in other examples, the PCB may be ring-shaped or define any other known shape. In some examples, the PCB 605 may include one or more light emitting diodes (LEDS) 610 configured to emit light through the respective lens (e.g., lens 310 or 315). For example, the LEDS 610 may be configured to emit white (e.g., non-RGB) light in order to illuminate a work piece during a work operation (e.g., cutting, crimping, etc.). For example, in response to actuation of the trigger 125, the LEDS 610 may activate and emit light through the lens (e.g., the lens 310, 315, or both).

In some examples, in addition to the LEDS 610, the PCB 605 may include one or more RGB LEDS 615. The RGB LEDS 615 may be configured to emit light through the respective lens (e.g., lens 310, 315, or both) in order to indicate a status of the tool 100 to an operator. For example, the RGB LEDS 615 may illuminate green when a successful crimp, cut, or other work operation is completed. In another example, the RGB LEDS 615 may illuminate red when an error occurs during a work operation. In some examples, the RGB LEDS may flash, pulse, remain illuminated, or emit light in predetermined patterns in order to indicate a status of the tool 100 to an operator. For example, the RGB LEDS 615 may flash red when a charge level of the battery 120 is low. In other examples, the RGB LEDS may illuminate in order to provide information to a user regarding tool temperature, tool pressure, or any other information relating to the status of the tool 100.

In some examples, the PCB 605 may include one LED 610 and one RGB LED 615 underneath the same lens (e.g., sharing a single lens). For example, a first LED 610 and a second RGB LED 615 may both be positioned underneath the lens 310. Thus, a single lens 310 may project light from both the LED 610 and the RGB LED 615. Further, in other examples, the LED 610 may be emitting light (e.g., in the form of a work light), while the RGB LED 615 may simultaneously illuminate in order to indicate a status of the tool 100. In some examples, rather than using a single LED 610 and a single RGB LED 615 underneath a single lens (e.g., lens 310), the indication system 185 may include multiple (e.g., more than one RGB LED 615) underneath a single lens. Correspondingly, the work light may include multiple (e.g., more than one LED 610) underneath the single lens. Further, rather than using a white light only LED, the LED 610 may instead be an RGB LED, but may be configured to emit white-yellow light to function as a work light.

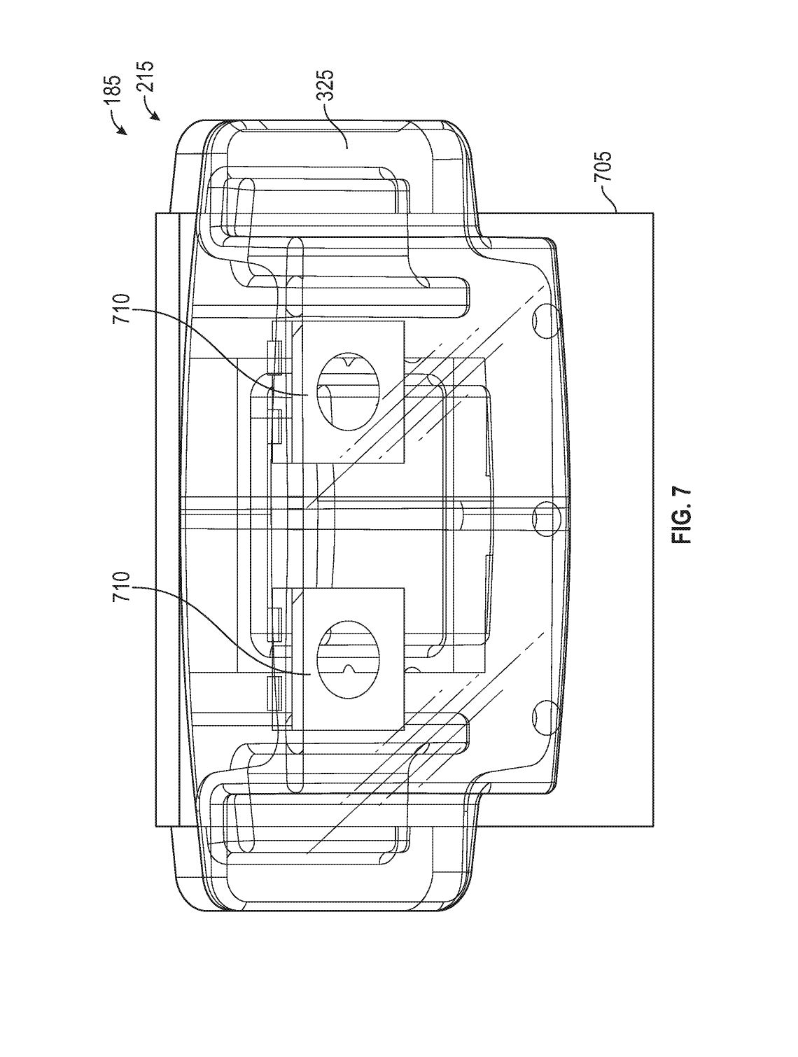

FIG. 7 shows an example of a PCB 705 for the second portion 215 of the indicator system 185. In some examples, the PCB may define a substantially rectangular shape. However, in other examples, the PCB may define any other known shape, such as semi-circular, ring-shaped, etc. In some examples, the PCB may include one or more RGB LEDS 710. For example, the PCB 705 may include a pair (e.g., two) RGB LEDS 710. However, in other examples, the PCB may include only a single RGB LED or may include more than two RGB LEDS.

In some examples, the RGB LEDS 710 may be positioned beneath the lens 325, so that the RGB LEDS may emit light in order to provide an indication of the status of the tool 100. For example, the RGB LEDS 710 may illuminate green when a successful crimp, cut, or other work operation is completed. In another example, the RGB LEDS 710 may illuminate red when an error occurs during a work operation. In some examples, the RGB LEDS may flash, pulse, remain illuminated, or emit light in predetermined patterns in order to indicate a status of the tool 100 to an operator. For example, the RGB LEDS 710 may flash red when a charge level of the battery 120 is low. As should be appreciated, in some examples, the RGB LEDS 710 may be configured to emit light simultaneously with the RGB LEDS 615. Thus, when the RGB LEDS 615 emit red light, the RGB LEDS 710 may simultaneously emit red light. As a result, the operator may be able to look at either the first portion 210 of the indicator system 185 or the second portion 215 of the indicator system 185 in order to determine a status of the tool 100.

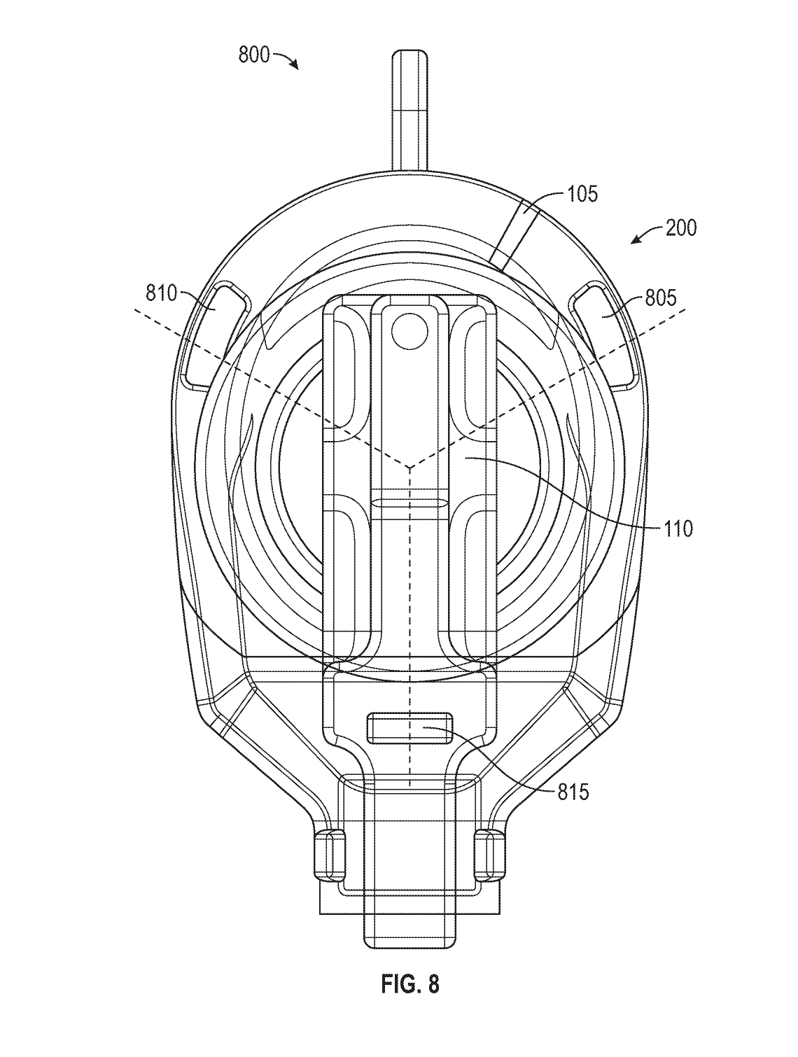

FIG. 8 illustrates another example of an indicator system 800 for use with the tool 200 (e.g., as an alternative configuration of the indicator system 185). As will be recognized, the indicator system 800 shares a number of components in common with and operates in a similar fashion to the examples illustrated and described previously. For the sake of brevity, these common features will not be again described below in detail. Rather, previous discussion of similarly named or numbered features, unless otherwise indicated, also applies to example configurations of the indicator system 800.

In some examples, rather than utilizing a pair of lenses (e.g., as shown in FIG. 4) the indicator system 800 may include three lenses, which may be spaced about 120-degrees apart around the working head 110. For example, a first lens 805, a second lens 810, and a third lens 815 may be spaced about 120-degrees apart around the working head 110 to form a Y-shape. In some examples, the first and second lenses 805, 810 may be configured to emit light from both a LED 610 and a RGB LED 615 (e.g., function as both a work light and the indicator system). However, the third lens 815 may be configured to only emit light from an LED 610 (e.g., function as a work light only). Further, in some examples, in order to facilitate this arrangement, a ring-shaped PCB may be positioned around an axis formed by the working head 110, with LEDS 610 and RGB LEDS 615 positioned underneath the lenses 805, 810 and LEDS 610 positioned underneath the lens 815.

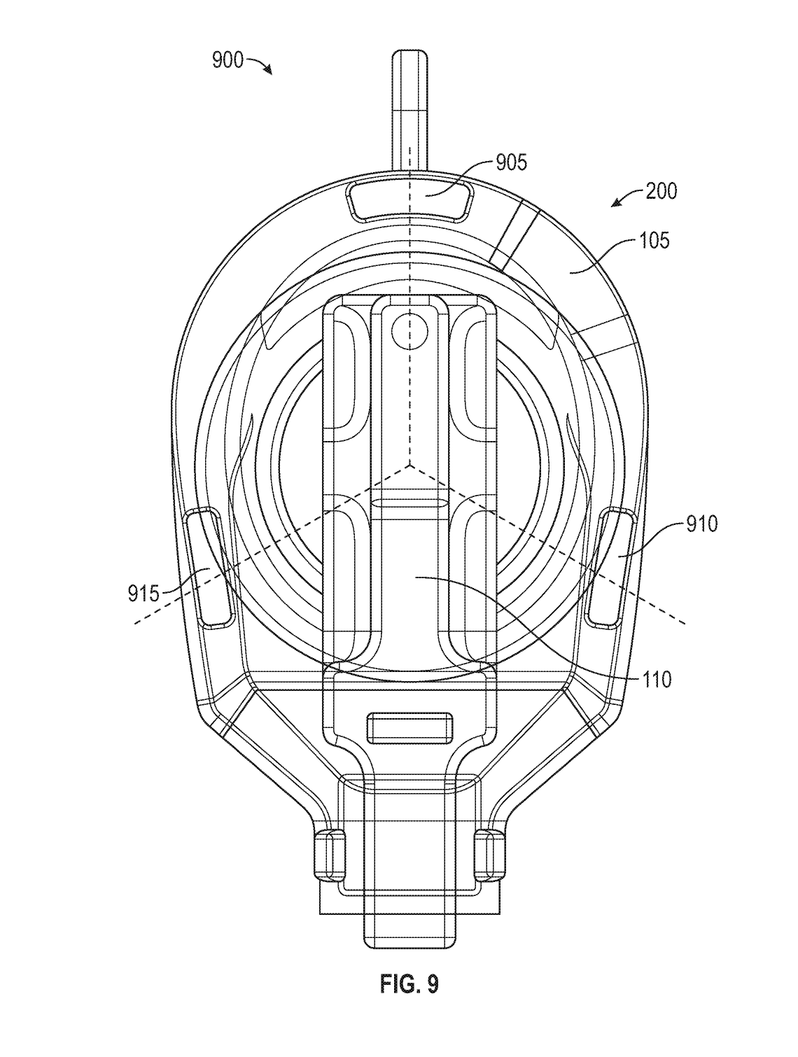

FIG. 9 illustrates another example of an indicator system 900 for use with the tool 200 (e.g., as an alternative configuration of the indicator system 185). As will be recognized, the indicator system 900 shares a number of components in common with and operates in a similar fashion to the examples illustrated and described previously. For the sake of brevity, these common features will not be again described below in detail. Rather, previous discussion of similarly named or numbered features, unless otherwise indicated, also applies to example configurations of the indicator system 900.

In some examples, the arrangement of the lenses (e.g., a first lens 905, a second lens 910, and a third lens 915) may be similar to the arrangement in FIG. 8. However, the lenses 905, 910, 915 may form an upside-down (e.g., inverse) Y-shape. For example, the lenses may be spaced about 120-degrees apart around the working head 110. In some examples, the first lens 905 may be configured to emit light from both a LED 610 and a RGB LED 615 (e.g., function as both a work light and the indicator system). However, the second and third lenses 910, 915 may be configured to only emit light from an LED 610 (e.g., function as a work light only). Further, in some examples, in order to facilitate this arrangement, a ring-shaped PCB may be positioned around an axis formed by the working head 110, with LEDS 610 and RGB LEDS 615 positioned underneath the lens 905 and LEDS 610 positioned underneath the lenses 910, 915.

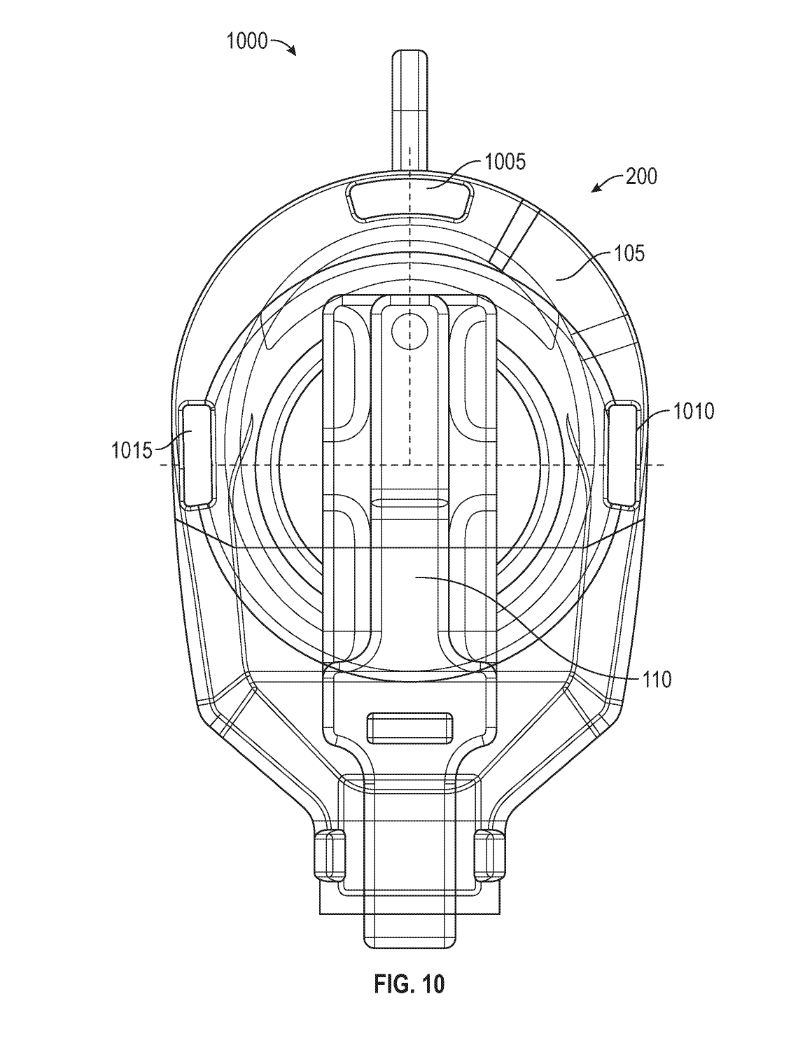

FIG. 10 illustrates another example of an indicator system 1000 for use with the tool 200 (e.g., as an alternative configuration of the indicator system 185). As will be recognized, the indicator system 1000 shares a number of components in common with and operates in a similar fashion to the examples illustrated and described previously. For the sake of brevity, these common features will not be again described below in detail. Rather, previous discussion of similarly named or numbered features, unless otherwise indicated, also applies to example configurations of the indicator system 1000.

In some examples, indicator system 1000 may include three lenses, which may be spaced about 90-degrees apart around the working head 110. For example, a first lens 1005, a second lens 1010, and a third lens 1015 may be spaced about 90-degrees apart around the working head 110 to form an inverse T-shape. In some examples, the first lens 1005 may be configured to emit light from both a LED 610 and a RGB LED 615 (e.g., function as both a work light and the indicator system). However, the second and third lenses 1010, 1015 may be configured to only emit light from an LED 610 (e.g., function as a work light only). Further, in some examples, in order to facilitate this arrangement, a PCB (e.g., of a circular, rectangular, semi-circular, or any other shape) may be positioned around an axis formed by the working head 110, with LEDS 610 and RGB LEDS 615 positioned underneath the lens 1005 and LEDS 610 positioned underneath the lenses 1010, 1015.

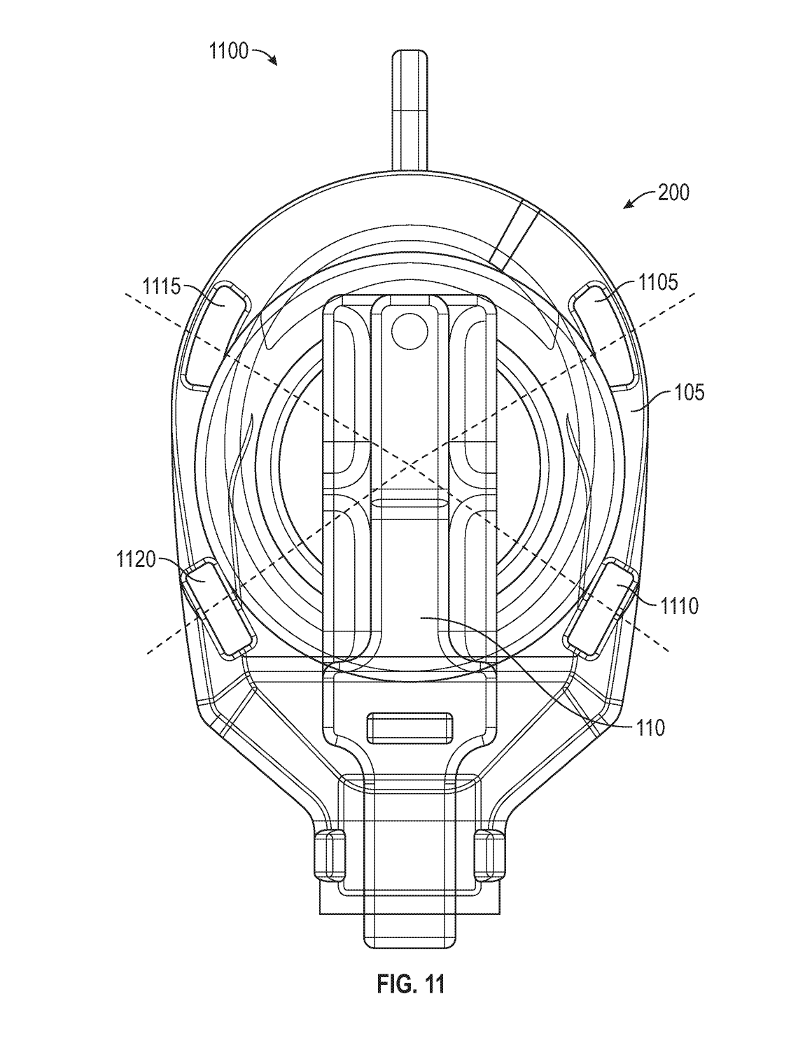

FIG. 11 illustrates another example of an indicator system 1100 for use with the tool 200 (e.g., as an alternative configuration of the indicator system 185). As will be recognized, the indicator system 1100 shares a number of components in common with and operates in a similar fashion to the examples illustrated and described previously. For the sake of brevity, these common features will not be again described below in detail. Rather, previous discussion of similarly named or numbered features, unless otherwise indicated, also applies to example configurations of the indicator system 1100.

In some examples, rather than utilizing a two or three lenses (e.g., as shown in FIGS. 4 and 8-10) the indicator system 1100 may include four lenses, which may form an X-shape. For example, a first lens 1105, a second lens 1110, a third lens 1115, and a fourth lens 1120 may form an X-shape. For example, the first lens 1105 and the second lens 1110 may be spaced about 60-degrees apart, while the first lens 1105 and the third lens 1115, and the second lens 1110 and the fourth lens 1120 may be spaced about 120-degrees apart. Further, the third lens 1115 and the fourth lens 1120 may be spaced about 60-degrees apart.

In some examples, the first and third lenses 1105, 1115 may be configured to emit light from both a LED 610 and a RGB LED 615 (e.g., function as both a work light and the indicator system). However, the second and fourth lenses 1110, 1120 may be configured to only emit light from an LED 610 (e.g., function as a work light only). Further, in some examples, in order to facilitate this arrangement, a ring-shaped PCB may be positioned around an axis formed by the working head 110, with LEDS 610 and RGB LEDS 615 positioned underneath the lenses 1105, 1115 and LEDS 610 positioned underneath the lenses 1110, 1120.

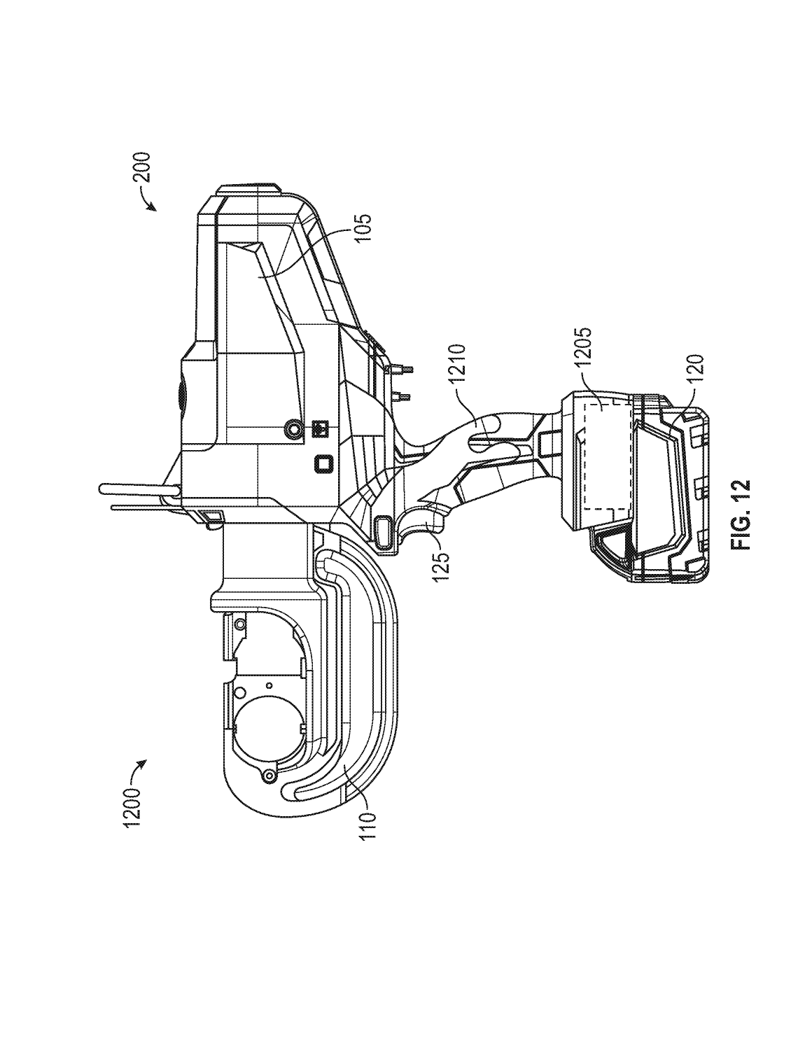

FIG. 12 illustrates another example of an indicator system 1200 for use with the tool 200 (e.g., as an alternative configuration of the indicator system 185). As will be recognized, the indicator system 1200 shares a number of components in common with and operates in a similar fashion to the examples illustrated and described previously. For the sake of brevity, these common features will not be again described below in detail. Rather, previous discussion of similarly named or numbered features, unless otherwise indicated, also applies to example configurations of the indicator system 1200.

In some examples, in lieu of the utilizing lenses to indicate the status of the tool 100 to an operator, the indicator system 1200 may include a display 1205. In some examples, the display 1205 may be positioned on a grip (e.g., handle) 1210 of the tool 100 (e.g., extending parallel to or perpendicular to an axis formed by the housing 105). In particular, the display 1205 may be positioned on the grip 1210 adjacent to the battery 120 in order to provide an indication of the status of the tool 100 to an operator. For example, the display 1205 may be a liquid crystal display (LCD), an LED display, or any other form of display.

In some examples, the display may continuously depict information related to the status of the tool 100. For example, the display 1205 may depict a battery percentage remaining, crimp success/failure, tool faults, tool pressure, tool temperature, or any other information related to the status of the tool 100. In some cases, rather than continuously depicting information (e.g., real-time information) relating to the tool 100, the display 1205 may instead depict information intermittently (e.g., on a predetermined interval) or whenever a fault/change in tool status is detected.

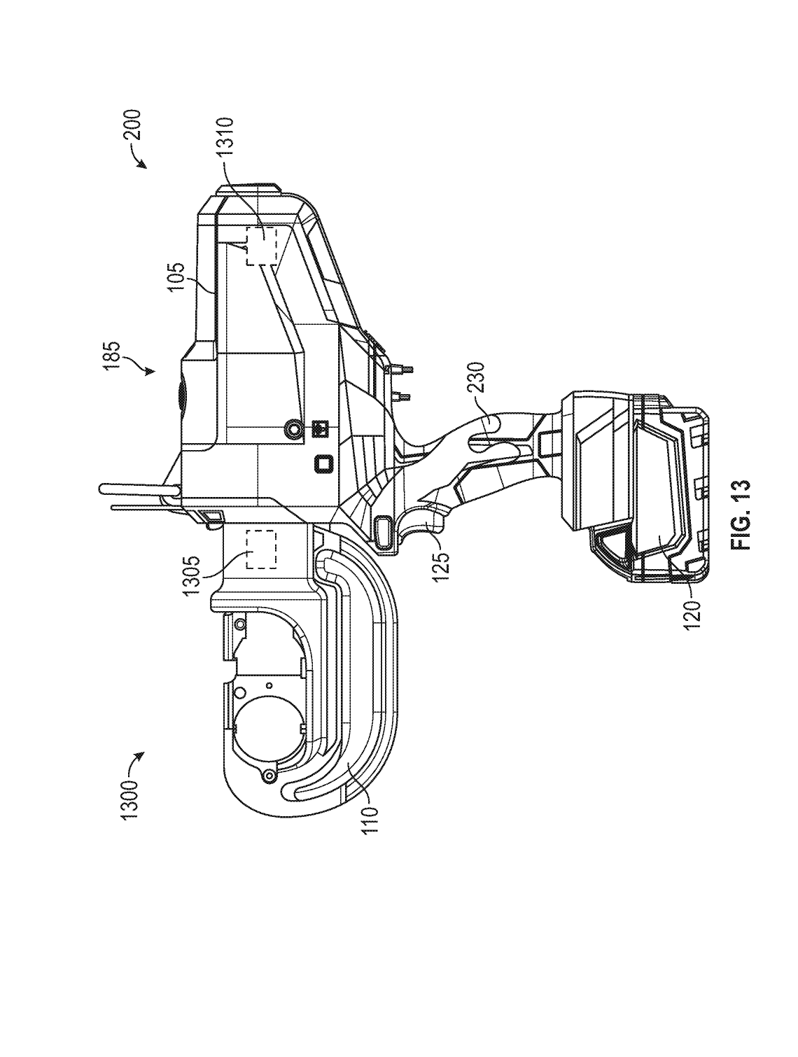

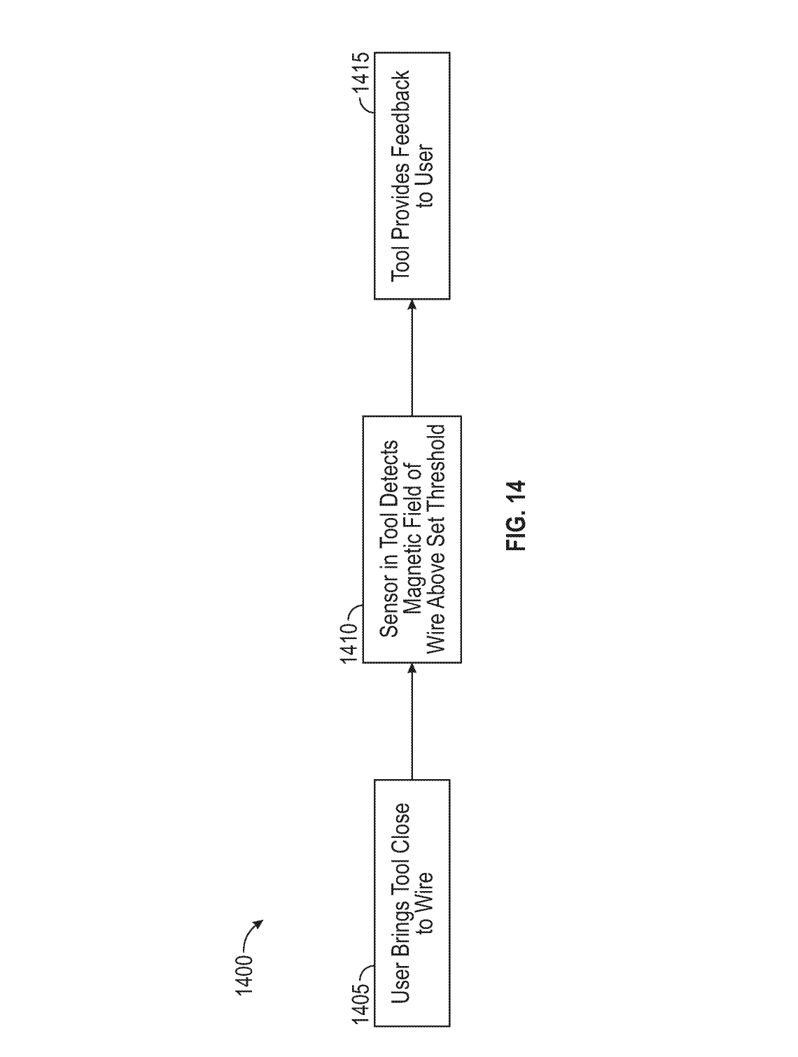

FIGS. 13 and 14 illustrate an example of a live wire indication system 1300. In some examples, the live wire indication system 1300 may include one or more sensors 1305, which may be positioned within the working head 110 of the tool 100. In some examples, the sensor(s) 1305 may be in the form of magnetic field sensors, voltage sensors, hall-effect sensors, magneto-resistive sensors (including giant magnetoresistance (GMR) and anisotropic magnetoresistance (AMR)), inductive sensors, reed switches, earth field sensors, etc. In some examples, the sensors 1305 may be configured to detect whether or not a wire, cable, or other work piece is currently live (e.g., power is flowing to/through the wire). Thus, the sensor 1305 may form a personal voltage detector, which may be configured to alert an operator to the status of the work piece.

For example, during use of the tool 200, at stage 1405 an operator may bring the tool 200 near to a work piece (e.g., a wire) that is currently live (e.g., has current running though wire). At stage 1410, during or prior to contact between the working head 110 of the tool 200 and the work piece, the sensor 1305 may detect a magnetic field given off by the work piece. Thus, at stage 1415, the controller 190 (e.g., in communication with the sensor 1305) may activate the indication system 185 (or any other indication system described herein) to provide visual, audible, tactile, or other feedback to an operator to alert the operator to a potentially unsafe condition. In some examples, in addition to the emission of light through the lenses of the indication system, the tool 200 may include an alternative feedback mechanism 1310 (e.g., a speaker, haptic feedback motor, or any other known alternative feedback mechanism) to provide an indication to an operator that the work piece may be live.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

### FURTHER EXAMPLES

Example 1. A hydraulic tool, comprising: a tool housing, the tool housing including a pedestal extending from the tool housing and defined by a first bezel and a second bezel on opposing sides of the pedestal; a head at a first end of the tool housing, the head to apply a mechanical force to a work piece; and an indicator system, the indicator system including: a first portion, the first portion including a lens extending through the first bezel of the pedestal; and a printed circuit board having a non-RGB LED and an RGB LED arranged underneath the same lens, the non-RGB LED and the RGB LED arranged to emit light through the same lens.

Example 2. The hydraulic tool of Example 1, wherein the indicator system further includes: a second portion, the second portion including a lens extending through the second bezel of the pedestal; and a printed circuit board having a RGB LED arranged underneath the same lens, the RGB LED arranged to emit light through the same lens to indicate a status of the tool.

Example 3. The hydraulic tool of Example 2, wherein the RGB LED of the first portion of the indicator system emits light through the same lens to indicate a status of the tool, and wherein the non-RGB LED of the first portion of the indicator system emits light through the same lens to illuminate a work piece during operation of the tool.

Example 4. The hydraulic tool of any one of Examples 2-3, wherein first portion of the indicator system emits light in a first direction and the second portion of the indicator system emits light in a second direction that is opposite the first direction.

Example 5. The hydraulic tool of any one of Examples 2-4, wherein the hydraulic tool is configured to: make a first determination that a cutting, crimping, or shearing operation that satisfies a predetermined criterion has been performed on the work piece by the head; and cause the indicator system to emit a first light color that corresponds to the first determination.

Example 6. The hydraulic tool of any one of Examples 2-5, wherein the hydraulic tool is configured to: make a second determination that a cutting, crimping, or shearing operation that satisfies a predetermined criterion has not been performed on the work piece by the head; and cause the indicator system to emit a second light color that corresponds to the second determination.

Example 7. The hydraulic tool of any one of Examples 1-6, wherein the first portion of the indicator system includes a first lens and a second lens, and wherein the printed circuit board has a non-RGB LED and an RGB LED arranged underneath both the first lens and the second lens.

Example 8. The hydraulic tool of any one of Examples 1-7, wherein the printed circuit board defines a semi-circular shape.

Example 9. A method of indicating a status of a hydraulic tool, the method comprising: providing a hydraulic tool having a housing, a working head coupled to the housing, and an indicator system including a lens with a non-RGB LED and an RGB LED arranged underneath the lens; performing a work operation on a work piece using the working head; determining whether the work operation satisfies a predetermined criterion; and causing the RGB LED to emit light through the lens in a first color when the work operation satisfies the predetermined criterion and in a second color, different from the first color, when the work operation does not satisfy the predetermined criterion.

Example 10. The method of Example 9, further comprising: emitting light from the non-RGB LED through the lens to illuminate the work piece during the work operation.

Example 11. The method of Example 10, wherein the non-RGB LED and the RGB LED emit light simultaneously through the lens during the work operation.

Example 12. The method of any one of Examples 9-11, wherein the housing includes a pedestal extending from the housing, the pedestal defined by a first bezel and a second bezel on opposing sides of the pedestal, and wherein the lens extends through the first bezel.

Example 13. The method of any one of Examples 9-12, wherein the non-RGB LED and the RGB LED are mounted on a printed circuit board having a semi-circular shape.

Example 14. The method of any one of Examples 9-13, wherein the indicator system further includes a second lens positioned on an opposing side of the housing from the lens, and wherein the method further includes: emitting light from a second RGB LED through the second lens simultaneously with the RGB LED emitting light through the lens.

Example 15. The method of any one of Examples 9-14, further comprising: causing the RGB LED to flash, pulse, or emit light in a predetermined pattern to indicate a status of the hydraulic tool to an operator.

Example 16. An indicator system for a hydraulic tool, comprising: a pedestal extending away from a housing of the hydraulic tool, the pedestal defined by a first bezel facing a working head of the hydraulic tool and a second bezel facing away from the working head; a first lens extending through the first bezel; a second lens extending through the second bezel; a first printed circuit board positioned beneath the first lens, the first printed circuit board having a non-RGB LED emitting light through the first lens to illuminate a work piece and an RGB LED emitting light through the first lens to indicate a status of the hydraulic tool; and a second printed circuit board positioned beneath the second lens, the second printed circuit board having an RGB LED emitting light through the second lens to indicate the status of the hydraulic tool.

Example 17. The indicator system of Example 16, wherein the RGB LED of the first printed circuit board and the RGB LED of the second printed circuit board emit light simultaneously to indicate the status of the hydraulic tool.

Example 18. The indicator system of any one of Examples 16-17, wherein the first printed circuit board defines a semi-circular shape.

Example 19. The indicator system of any one of Examples 16-18, wherein the first bezel defines a sloped surface, and wherein the first lens extends through an opening in the sloped surface.

Example 20. The indicator system of any one of Examples 16-19, wherein the first lens and the second lens emit light in opposite directions.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within ± 12 degrees of a reference direction (e.g., within ± 6 degrees), inclusive.

Also as used herein, unless otherwise limited or defined, “substantially perpendicular” indicates a direction that is within ± 12 degrees of perpendicular a reference direction (e.g., within ± 6 degrees), inclusive.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of ± 15% or less, inclusive of the endpoints of the range. Similarly, the term “substantially equal” (and the like) as used herein with respect to a reference value refers to variations from the reference value of less than ± 10%, inclusive. Where specified, “substantially” can indicate in particular a variation in one numerical direction relative to a reference value. For example, “substantially less” than a reference value (and the like) indicates a value that is reduced from the reference value by 10% or more, and “substantially more” than a reference value (and the like) indicates a value that is increased from the reference value by 10% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

The above detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

It is to be understood that the invention is not limited in its application to the details of construction and the arrangement of components set forth in the above description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A hydraulic tool, comprising:
a tool housing, the tool housing including a pedestal extending from the tool housing and defined by a first bezel and a second bezel on opposing sides of the pedestal;
a head at a first end of the tool housing, the head to apply a mechanical force to a work piece; and
an indicator system, the indicator system including:
a first portion, the first portion including a lens extending through the first bezel of the pedestal; and
a printed circuit board having a non-RGB LED and an RGB LED arranged underneath the same lens, the non-RGB LED and the RGB LED arranged to emit light through the same lens.

2. The hydraulic tool of claim 1, wherein the indicator system further includes:
a second portion, the second portion including a lens extending through the second bezel of the pedestal; and
a printed circuit board having a RGB LED arranged underneath the same lens, the RGB LED arranged to emit light through the same lens to indicate a status of the tool.

3. The hydraulic tool of claim 2, wherein the RGB LED of the first portion of the indicator system emits light through the same lens to indicate a status of the tool, and wherein the non-RGB LED of the first portion of the indicator system emits light through the same lens to illuminate a work piece during operation of the tool.

4. The hydraulic tool of claim 2, wherein first portion of the indicator system emits light in a first direction and the second portion of the indicator system emits light in a second direction that is opposite the first direction.

5. The hydraulic tool of claim 2, wherein the hydraulic tool is configured to:
make a first determination that a cutting, crimping, or shearing operation that satisfies a predetermined criterion has been performed on the work piece by the head;
cause the indicator system to emit a first light color that corresponds to the first determination;
make a second determination that a cutting, crimping, or shearing operation that satisfies the predetermined criterion has not been performed on the work piece by the head; and
cause the indicator system to emit a second light color, different from the first light color, that corresponds to the second determination.

6. The hydraulic tool of claim 1, further comprising:
a sensor positioned adjacent to the head, the sensor configured to detect a magnetic field; and
wherein the hydraulic tool is configured to activate the indicator system to provide feedback to an operator when the sensor detects the magnetic field above a threshold.

7. The hydraulic tool of claim 1, wherein the first portion of the indicator system includes a first lens and a second lens, and wherein the printed circuit board has a non-RGB LED and an RGB LED arranged underneath both the first lens and the second lens.

8. The hydraulic tool of claim 1, wherein the printed circuit board defines a semi-circular shape.

9. A method of indicating a status of a hydraulic tool, the method comprising:
providing a hydraulic tool having a housing, a working head coupled to the housing, and an indicator system including a lens with a non-RGB LED and an RGB LED arranged underneath the lens;
performing a work operation on a work piece using the working head;
determining whether the work operation satisfies a predetermined criterion; and
causing the RGB LED to emit light through the lens in a first color when the work operation satisfies the predetermined criterion and in a second color, different from the first color, when the work operation does not satisfy the predetermined criterion.

10. The method of claim 9, further comprising:
emitting light from the non-RGB LED through the lens to illuminate the work piece during the work operation.

11. The method of claim 10, wherein the non-RGB LED and the RGB LED emit light simultaneously through the lens during the work operation.

12. The method of claim 9, wherein the housing includes a pedestal extending from the housing, the pedestal defined by a first bezel and a second bezel on opposing sides of the pedestal, and wherein the lens extends through the first bezel.

13. The method of claim 9, wherein the non-RGB LED and the RGB LED are mounted on a printed circuit board having a semi-circular shape.

14. The method of claim 9, wherein the indicator system further includes a second lens positioned on an opposing side of the housing from the lens, and wherein the method further includes:
emitting light from a second RGB LED through the second lens simultaneously with the RGB LED emitting light through the lens.

15. The method of claim 9, further comprising:
causing the RGB LED to flash, pulse, or emit light in a predetermined pattern to indicate a status of the hydraulic tool to an operator.

16. An indicator system for a hydraulic tool, comprising:
a pedestal extending away from a housing of the hydraulic tool, the pedestal defined by a first bezel facing a working head of the hydraulic tool and a second bezel facing away from the working head;
a first lens extending through the first bezel;
a second lens extending through the second bezel;
a first printed circuit board positioned beneath the first lens, the first printed circuit board having a non-RGB LED emitting light through the first lens to illuminate a work piece and a first RGB LED emitting light through the first lens to indicate a status of the hydraulic tool; and
a second printed circuit board positioned beneath the second lens, the second printed circuit board having a second RGB LED emitting light through the second lens to indicate the status of the hydraulic tool.

17. The indicator system of claim 16, wherein first RGB LED of the first printed circuit board and the second RGB LED of the second printed circuit board emit light simultaneously to indicate the status of the hydraulic tool.

18. The indicator system of claim 16, wherein the first printed circuit board defines a semi-circular shape.

19. The indicator system of claim 16, wherein the first bezel defines a sloped surface, and wherein the first lens extends through an opening in the sloped surface.

20. The indicator system of claim 16, wherein the first lens and the second lens emit light in opposite directions.
